(19) United States
(12) Patent Application Publication
(10) Pub. No.: US 2008/0256460 A1
(43) Pub. Date: Oct. 16, 2008

(54) COMPUTER-BASED ELECTRONIC INFORMATION ORGANIZER

(76) Inventor: John F. Bickmore, Aurora, CO (US)

Correspondence Address: MARSH, FISCHMANN & BREYFOGLE LLP, 8055 East Tufts Avenue, Suite 450, Denver, CO, 80237, US

(21) Appl. No.: 11/946,630

(22) Filed: Nov. 28, 2007

Related U.S. Application Data
(60) Provisional application No. 60/861,312, filed on Nov. 28, 2006.

(51) Int. Cl. G06F 3/00

(52) U.S. Cl. 715/752

(57) ABSTRACT

A computer-implemented method for organizing and presenting electronic information on a client device. The method can include enabling a user to create a plurality of topics by inputting criteria that define each of the topics. A plurality of electronic items are then automatically associated with the topics by applying the criteria to the electronic items. The electronic items can include at least two different electronic items from different electronic sources, such as e-mail accounts, newsgroups, blog websites or web feeds. A user interface is displayed on a client device where the topics are displayed to the user to enable the user to select a topic and display a list of the electronic items that have been automatically associated with the selected topic. The user can select and manipulate an electronic item from the list of electronic items that is associated with the selected topic.

### CROSS-REFERENCE TO RELATED APPLICATIONS

This application claims priority to U.S. Provisional Patent Application Ser. No. 60/861,312, filed on Nov. 28, 2006, which is incorporated herein by reference in its entirety.

### BACKGROUND OF THE INVENTION

1. Field of the Invention

The present invention relates to computer-based methods and systems and in particular to methods and systems for topically organizing disparate types of electronic items to facilitate access to and manipulation of the electronic items by a user.

2. Description of Related Art

The proliferation of electronic communications has enabled users of computers and other devices to receive a great deal of information in electronic form, such as electronic mail (e-mail) and web feeds, such as RSS feeds. In addition, users can access a great deal of information over the Internet about topics that are of interest to the user, such as by accessing World Wide Web pages or newsgroups. Further, the storage capacity on client devices such as computers, personal digital assistants (PDAs) and similar communication devices has increased greatly and a user can have many files of different types located on the user's client device, or on a server that is accessed by a client device, such as on a local area network (LAN) or a wide area network (WAN).

One problem that has been encountered is that the volume of information that is available to a user can be overwhelming. A user can have difficulty tracking and organizing the electronic information in a manner that permits the user to readily identify and select an electronic item of information, without always filtering through the other items of information that are not of interest to the user at that particular time. This is compounded by the fact that the information can take many forms, and the different electronic items can come from many different sources.

Another related problem is that a user will often need to have access to more than one source for the same type of electronic item. For example, many users now have multiple e-mail accounts, such as one or more personal e-mail accounts through an Internet Service Provider (ISP) and an e-mail account at the user's place of employment that is hosted by the employer and is accessed through a POP3 client. To access the different sources, a user must set up different accounts on an e-mail client such as Outlook Express (Microsoft Corp., Redmond, Wash.) and/or retrieve the different items by navigating separately to each source, providing security credentials, and logging into the remote server where the e-mail is stored.

### SUMMARY OF THE INVENTION

Accordingly, it is an object of the present invention to provide a method of automatically organizing electronic items for a user that will overcome the deficiencies of the prior art methods, including different types of electronic items and electronic items from different sources.

Another object of the present invention is to provide a method for topically organizing disparate types of electronic items that reduces the amount of effort needed by a user to obtain the electronic items from multiple sources.

Another object of the present invention is to provide a method for topically organizing disparate types of electronic items that enables a user to organize the electronic items from any source by automatically applying user-defined topic criteria.

Another object of the present invention is to provide a method for topically organizing electronic items, where the electronic items originate from different electronic item sources.

Another object of the present invention is to provide a method for topically organizing disparate types of electronic items, where the electronic items originate from different electronic item locations.

Another object of the present invention is to provide a method for topically organizing disparate types of electronic items, where a user-defined topic can include user-defined subtopics to create a hierarchal topic list.

Another object of the present invention is to provide a method for topically organizing disparate types of electronic items by providing a graphical user interface where an electronic item under a selected topic can be manipulated such as by reading, viewing, hearing, filtering, modifying, deleting, acting upon or responding to the electronic item without regard to the electronic item type or electronic item source.

Another object of the present invention is to provide a method for organizing and displaying electronic items within a topic or subtopic by searching and filtering to create new focused result sets of the items, without changing the electronic items original association with one or more topics, and if applicable, corresponding subtopics.

Another object of the present invention is to provide a method of topically organizing information that enables a user to communicate electronic items associated with one or more topics to other users and to receive electronic items from other users.

According to one embodiment of the present invention, a computer-implemented method for organizing and presenting electronic item information on a client device is provided. The method includes the steps of enabling a user to select at least a first electronic item source and a second electronic item source that is different than the first electronic item source. The user is also enabled to create at least a first topic having a topic name by inputting topic criteria that defines the topic. A plurality of electronic items is associated with the topic by applying topic criteria to the electronic items, where the plurality of electronic items includes at least electronic items from the first electronic source and electronic items from the second electronic item source. A user interface is displayed on the client device where the topic name is displayed to the user to enable the user to select the topic and display a list of electronic items that have been associated with the topic. According to one aspect, the user can select and manipulate an electronic item from the list of electronic items that is associated with the first topic.

According to another aspect, the first and second electronic item sources are selected from the group consisting of news groups, e-mail accounts, websites and web feeds. The electronic item sources can be different sources of the same type of electronic item. For example, the first electronic item source can be a first e-mail account and the second electronic item source can be a second e-mail account that is different than the first e-mail account.

According to a further aspect, the first e-mail account can be located on a first e-mail server and the second e-mail account can be located on a second e-mail server that is different than the first e-mail server. Thus, e-mail items from different e-mail accounts and/or from different locations (i.e., different e-mail servers) can be organized and displayed to the user.

According to another aspect, the plurality of electronic items can include an electronic item selected from the group consisting of an e-mail item, a newsgroup posting, a video file, an audio file, an image file, a blog entry, and a web feed item.

According to another aspect, the topic criteria that define the first topic can include key words that are associated with the electronic items.

According to another aspect, the step of enabling the user to select and manipulate an electronic item from the displayed list of electronic items includes enabling a user to delete the selected electronic item.

According to another aspect, the step of enabling the user to select and manipulate an electronic item from the displayed list of electronic items includes enabling the user to open and view the selected electronic item. According to a further aspect, the list of electronic items includes a GUI widget for opening an electronic item wherein the electronic item is automatically opened using a program that is associated with the type of electronic item.

According to one aspect, the plurality of electronic items comprises at least an e-mail item and a newsgroup posting.

According to another aspect, the plurality of electronic items includes at least an e-mail item and a web feed item.

According to another aspect, the step of enabling the user to create a topic includes enabling a user to create a plurality of topics. According to a further aspect, the user is enabled to create a subtopic associated with the topic for creating a hierarchal list comprising topics and subtopics with which electronic items are associated.

According to another aspect, the method includes the step of enabling a user to filter the list of electronic items associated with the topic to create a focused result set comprising a portion of electronic items that are associated with the topic. According to a further aspect, the focused result set is based upon dates that are associated with the electronic items. According to another aspect, the focused result set is based upon the electronic item type.

According to another embodiment, a computer-implemented method for organizing and presenting electronic item information on a client device is provided. The method includes the steps of enabling a user to select at least a first electronic item source and a second electronic item source, where the second electronic item source is different than the first electronic item source. The method also includes enabling the user to create a plurality of topics by inputting topic criteria to a database that defines each of the topics. Electronic items are associated with the topics by applying the topic criteria to the electronic items. The electronic items include at least electronic items from the first electronic item source and electronic items from the second electronic item source. The user interface is displayed on the client device where the topics are displayed to the user to enable the user to select a topic and display a list of electronic items that have been associated with the selected topic. The method includes enabling a user to filter the list of electronic items associated with the selected topic to create a focused result set comprising a portion of the electronic items that are associated with the topic. The method also includes the step of enabling the user to select and manipulate an electronic item from the list of electronic items that are associated with the selected topic.

According to one aspect, the electronic items from the first electronic item source are electronic items of a first electronic item type and electronic items from the second electronic item source are electronic items of a second electronic item type that is different than the first electronic item type. For example, the first electronic item type could be an e-mail item and the second electronic item type could be a newsgroup posting.

These and other embodiments and aspects of the present invention will become apparent from the following description.

### DESCRIPTION OF THE DRAWINGS

FIG. 1 illustrates a process flow chart of a method for topically organizing information according to an embodiment of the present invention.

FIG. 2 illustrates a screen capture of a graphical user interface for enabling a user to input item source information in a method for topically organizing information according to an embodiment of the present invention.

FIG. 3 illustrates a screen capture of a graphical user interface for enabling a user to input item source information relating to a blog source in a method for topically organizing information according to an embodiment of the present invention.

FIG. 4 illustrates a screen capture of a graphical user interface for enabling a user to input item source information for a web feed source in a method for topically organizing information according to an embodiment of the present invention.

FIG. 5 illustrates a screen capture of a graphical user interface for creating topics by enabling a user to input topic criteria in a method for topically organizing information according to an embodiment of the present invention.

FIG. 6 illustrates a screen capture of a graphical user interface for enabling a user to create a topic by inputting topic criteria in a method for topically organizing information according to an embodiment of the present invention.

FIG. 7 illustrates a screen capture of a graphical user interface for enabling a user to input topic criteria including topic and subtopic associations in a method for topically organizing information according to an embodiment of the present invention.

FIG. 8 illustrates a screen capture of a graphical user interface for enabling a user to input topic criteria including item source criteria in a method for topically organizing information according to an embodiment of the present invention.

FIG. 9 illustrates a screen capture of a graphical user interface for enabling a user to input topic criteria including item source criteria in a method for topically organizing information according to an embodiment of the present invention.

FIG. 10 illustrates a screen capture of a graphical user interface for enabling a user to filter a list of electronic items associated with a topic in a method for topically organizing information according to an embodiment of the present invention.

FIG. 11 illustrates a screen capture of a graphical user interface for reading a newsgroup posting in a method for topically organizing information according to an embodiment of the present invention.

FIG. 12 illustrates a screen capture of a graphical user interface in a method for topically organizing information according to an embodiment of the present invention.

### DESCRIPTION OF THE INVENTION

The present invention provides a method and system for the organizing and presenting of disparate types of electronic information items by user-defined topics on a client device. The electronic items can be topically organized and displayed to a user in a manner that readily permits the user to identify and manipulate electronic items of interest. The electronic information items can be from different sources, and can also be of different electronic item types thereby enabling a user to automatically organize disparate types of electronic items.

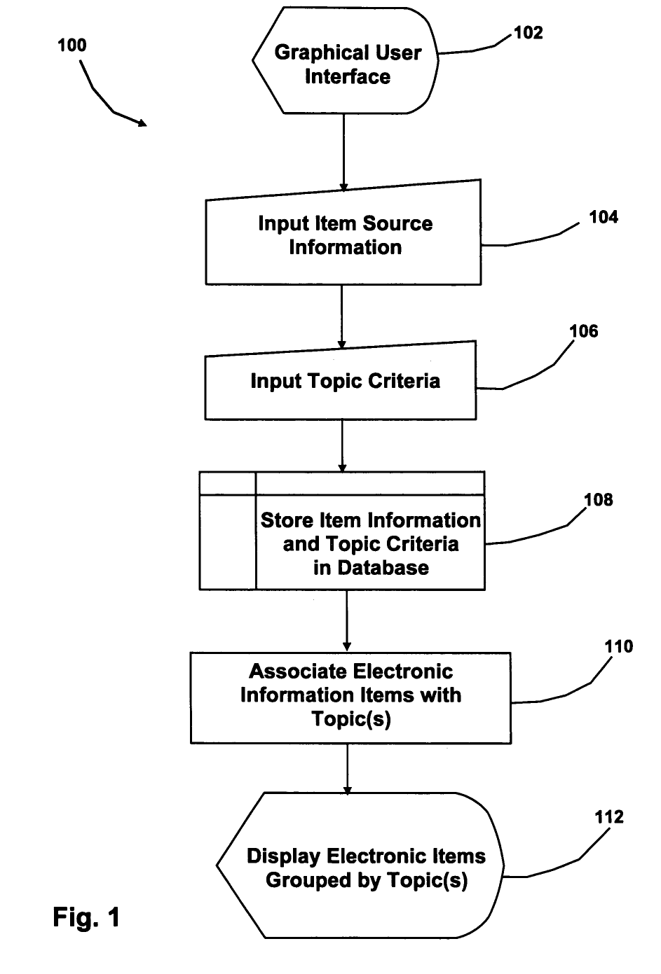

FIG. 1 is a process flow chart 100 illustrating a method for creating topics and topically organizing items of electronic information using the user-created topics, including electronic information items of different types and from different sources. A user opens a graphical user interface (GUI) 102 from a client device. The user can access the graphical user interface 102 using a computer, or by using another client device that is capable of communicating with and accessing an electronic database, displaying information to a user and receiving input from the user, such as a web-based phone or personal digital assistant (PDA).

From the graphical user interface 102, the user inputs electronic item source information 104 to identify the sources of electronic items and therefore also the types of electronic items that are to be associated with topics for that user. For example, the electronic item types can vary widely and can include, but are not limited to: electronic mail items; newsgroup postings; blog entries; web feed items such as news articles through RSS (XML), Atom or other web feed protocols; instant messaging (IM) items; media files, such as video files, audio files or picture files; stock or mutual fund price information; or search engine rankings.

It will be appreciated that electronic items of the same or similar type can originate from different sources. For example, a user may have multiple e-mail accounts on one or more e-mail servers, or may be interested in entries made to multiple blog websites or postings to multiple newsgroups. According to the present invention, the sources of electronic items can include virtually any source that can be queried to retrieve the item itself (e.g., an e-mail from a POP3 e-mail server), or to retrieve sufficient information about the item such that the item can be uniquely identified and displayed to a user (e.g., a blog entry). The electronic item source can be accessed through, for example, a local area network (LAN) or a wide area network (WAN) such as the internet. Accordingly, sources of electronic items can include, but are not limited to: e-mail accounts located on electronic mail servers, including POP3/SMTP mail servers and web-based mail servers; newsgroups located on news servers (usenet); websites, including blog websites located on remote servers, or websites that contain multimedia files (e.g., www.youtube.com); and web feeds located on remote servers, such as RSS (XML) or Atom web feeds. Other sources of electronic items can include a Microsoft Active Directory, a Microsoft Exchange Server or a Microsoft Message Queue. For example, changes to the Active Directory can be monitored and the information about the change can be associated with one or more appropriate topics. Items of information on an Exchange Server, such as e-mails, calendar items, contacts and the like can also be monitored and changes or additions can be associated with one or more topics. Microsoft Message Queue (MSMQ) enables applications running at different times to communicate across heterogeneous networks and systems that may be temporarily offline. In this instance, communications going through the queue can be monitored and those electronic items can be associated with one or more topics.

When inputting the item source information, the user provides sufficient information to both identify and access the information source. For example, if the electronic item source is an e-mail account on a POP3 mail server, the user can input the e-mail account name (e.g., John@comcast.net) the name of the POP3 mail server (e.g., mail.comcast.net) and, if desired, the name of the corresponding SMTP outgoing mail server (e.g., smtp.comcast.net). A username and password are also provided by the user if they are required to access the mail account. To include a newsgroup containing newsgroup postings, a user can input the name of the newsgroup, the name of the news server where the newsgroup resides, as well as a user name and password if they are necessary to access the news server. Some types of electronic items will only require the user to input the location of the source, such as the uniform resource locator (URL) for a website containing a blog or the URL of a web feed. Thus, the user can input a wide variety of disparate electronic item types and electronic sources.

According to the present invention, the user creates unique user-defined topics by inputting topic criteria 106 that uniquely define each topic that is of interest to the user. By carefully creating topic criteria for a plurality of topics, the user can limit the number of electronic items that are displayed to the user and can organize those electronic items in a way that facilitates the review of the items by the user.

In this regard, the topic criteria that are input to define one or more topics can be criteria that derive from any data that can be obtained by querying (e.g., searching) the electronic items of interest. For example, the topic criteria can include keywords that are contained in the electronic items, or in meta-data associated with the electronic items, such as the name of the author of a document, or the name (e.g., the path) of the originating computer. The user can input topic criteria on an inclusion basis (i.e., to include in the topic items containing the input keywords) or an exclusion basis (i.e., to exclude items from the topic that contain the input keywords). The topic criteria can also include, for example, criteria relating to a date that is associated with the electronic item, such as the date that the electronic item was first received or created.

The topic criteria and the electronic item type and source information can be stored in a database 108 resident on an electronic storage medium. By applying the electronic item type and source information input by the user at 104, the system can retrieve the electronic items, or can retrieve sufficient information to identify the electronic items that are resident on a remote server. Access to electronic items can also be provided to the user through a proxy server. Electronic items located at the electronic item sources input by the user can be retrieved from their location (e.g., a remote server) and stored in a database. Alternatively, the retrieval of electronic items can be limited to only those electronic items that match topic criteria input by the user to define topics. Further, using the electronic source information provided by the user, the electronic sources are monitored (e.g., queried) on a periodic basis to continually identify new electronic items at those sources and associate those new electronic items with user-defined topics for display to the user.

The database containing the electronic item source information can be resident on the client device, or can be accessed by connecting the client device to a network, such as a LAN or a WAN. In one embodiment, the database is accessed by a user through a WAN such as the internet. In one embodiment, the electronic database is accessed through the internet and multiple users are provided with access to the electronic database by providing security credentials and logging into the database. In this regard, the administrator of the electronic database can charge a fee to users for access to the electronic database, or otherwise generate revenue such as by the placement of advertisements in the graphical user interface when a user accesses the electronic database.

Once electronic items have been associated with a topic, a graphical user interface 112 is displayed to the user at the client device, whereby the electronic items are automatically organized for the user by the user-defined topics, and are displayed to the user such that the user can manipulate the electronic items. As used herein, manipulate means to act upon the electronic item in any way, such as by opening, replying to, forwarding or deleting the electronic item from the graphical user interface 112.

It will be appreciated that an electronic item can be associated with more than one topic if that item meets the requirements of more than one set of topic criteria input by the user. Also, an electronic item from an input electronic item source may not be associated with any topic if the criteria for the user-created topics do not match the electronic item.

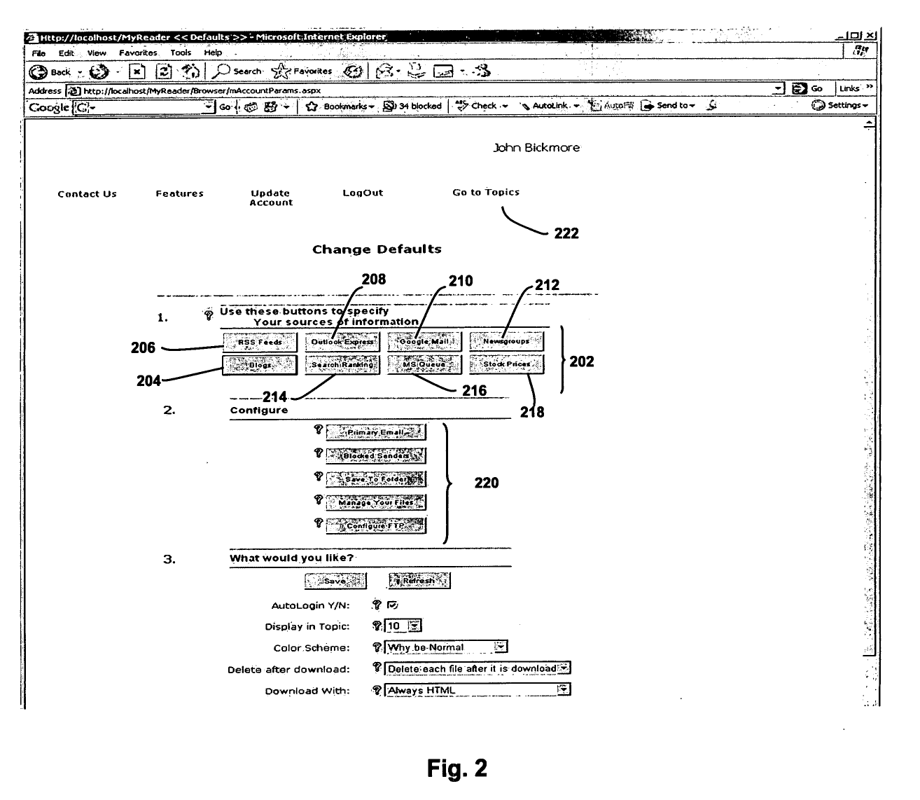

FIG. 2 illustrates a GUI for inputting item source information in a method for topically organizing information, such as at step 104 of FIG. 1. After the user logs into the system, such as by providing a user name and password to securely access a user's account, the user can then input the sources of electronic items the user wishes to access, such as by selecting an electronic item source or type from the widget group 202. As illustrated in FIG. 2, a user can select electronic item sources or types from among RSS feeds, a POP3 mail server (e.g., through Outlook Express), a web-based mail server (e.g., Google mail), newsgroups, blogs, search engine rankings, MS Queue and stock prices.

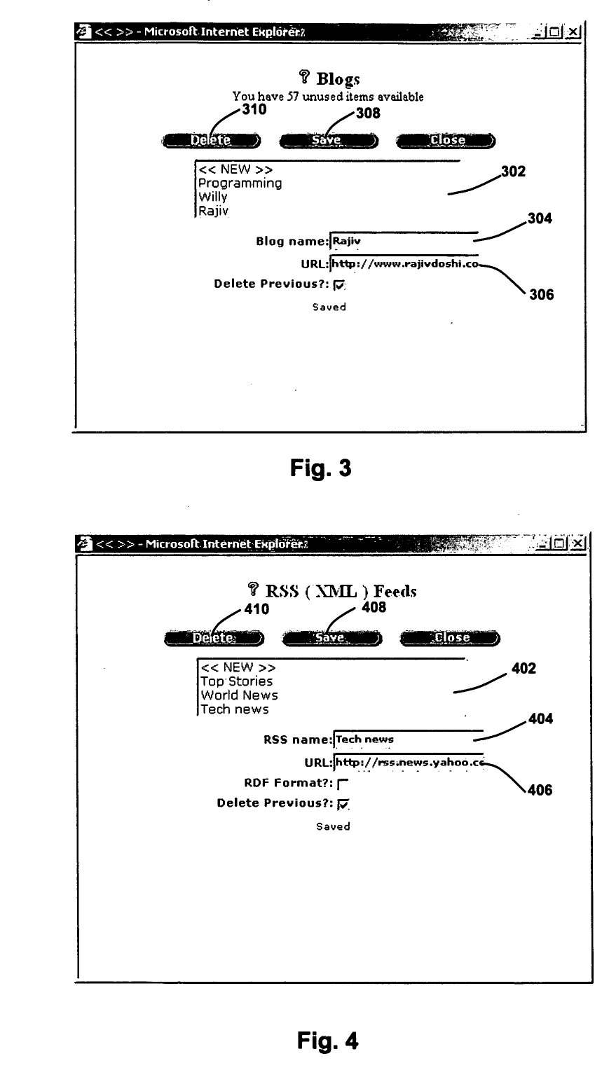

For example, by selecting the Blogs widget 204, a graphical user interface such as that illustrated in FIG. 3 is displayed to the user. Referring to FIG. 3, the user is presented with a list 302 of previously input Blog names, and the option to create a new Blog from a blog website. The user can input a unique name for the blog in text box 304, and the URL source for the Blog in text box 306. The user can then select Save 308 to save this item source information and the newly created Blog will be available to the user as a source of electronic items, namely blog entries. The input source will then be monitored to determine if new electronic items, in this case a new blog entry, have been added. The user is also presented with the option to delete a previously created Blog source by selecting the Delete widget 310.

Referring back to FIG. 2, a user can also select the RSS Feeds widget 206, which will present the user with a graphical user interface such as that illustrated in FIG. 4. Referring to FIG. 4, a list 402 of previously entered RSS feeds is listed, along with the option to create a new RSS feed. The user gives the RSS feed a unique name in text box 404 and provides the URL source for the RSS feed in text box 406. The user can then select the Save widget 408 to save this RSS feed source and name information. The user is also presented with the option to delete a previously created RSS feed source using the Delete widget 410.

Referring back to FIG. 2, it is noted that other sources and types of electronic items can be identified from the graphical user interface. For example, selecting the Outlook Express widget 208 will enable the user to input the name of the item source, namely a POP3 e-mail account, and input the e-mail account address, mail server location as well as user name and password information as appropriate to access the account. Selecting the Google Mail widget 210, which represents a web-based e-mail account, will require the user to input the source information (i.e., the e-mail address information) for that server location. Selecting the Newsgroups widget 212 will enable the user to create a newsgroup source by inputting the name of a news server, as well as the specific newsgroup that the user wishes to access from the news server, and account information such as user name and password, if needed to access the news server.

Selecting the Search Ranking widget 214 will enable a user to input the name of a search engine as well as search terms for a pre-defined search and a target website. The system will then periodically run a search using the input search terms on the designated search engine and determine the ranking of the target web site in the search results. This feature is useful for marketing and advertising purposes.

Selecting the MS Queue widget 216 will enable a user to input the address of a Microsoft Message Queue and monitor electronic items that are passed through the queue.

Selecting the Stock Prices widget 218 will enable a user to input the symbols for a stock or mutual fund and the system will retrieve price information relating to that stock or fund.

The user is also provided with the option to configure other aspects of the system from the widget group 220, such as by setting the primary e-mail account used to respond to certain electronic items, and by enabling the user to block items from certain senders (e.g., from e-mail addresses or newsgroup posters), and by selecting a specific folder to which attachments can be saved.

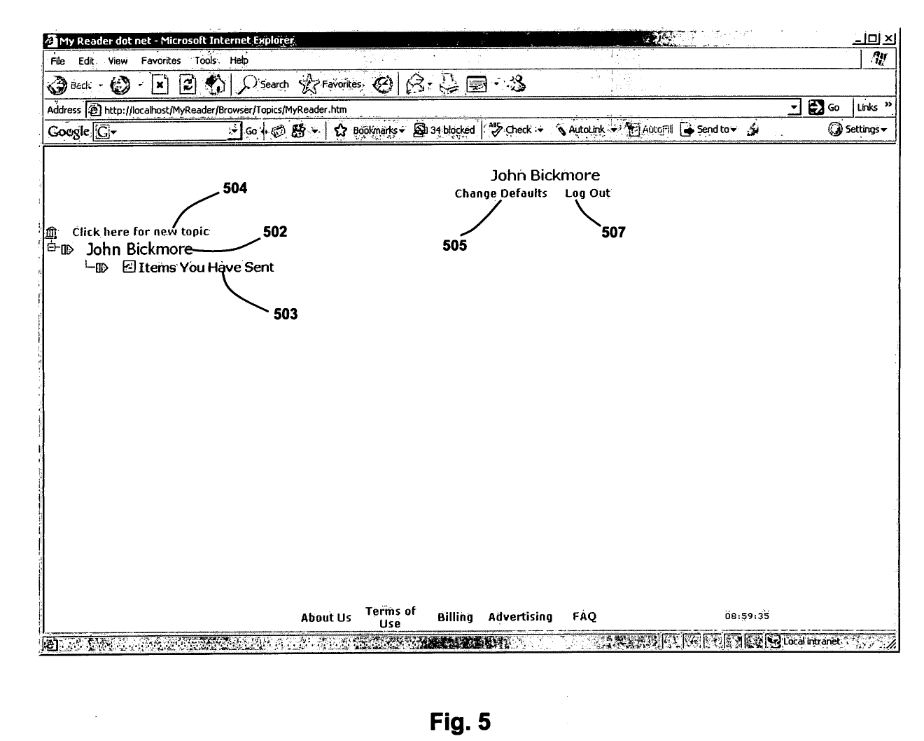

FIG. 5 illustrates a GUI of an information organizer when a user accesses the information organizer, such as by selecting the Go To Topics widget 222 (FIG. 2). A user name 502 associated with the logged-in user is displayed on the left side of the GUI.

As is illustrated in FIG. 5, a pre-defined topic Items You Have Sent 503 is automatically generated for the user. The user can add new topics and subtopics to the topic list by selecting the New Topic widget 504 to enable the addition of a new topic or the addition of a new subtopic to the topic list. In addition, the user is presented with a Change Defaults widget 505 to return to the set-up screen, such as that illustrated in FIG. 2. The user is also presented with a Log Out widget 507 to log out of the system.

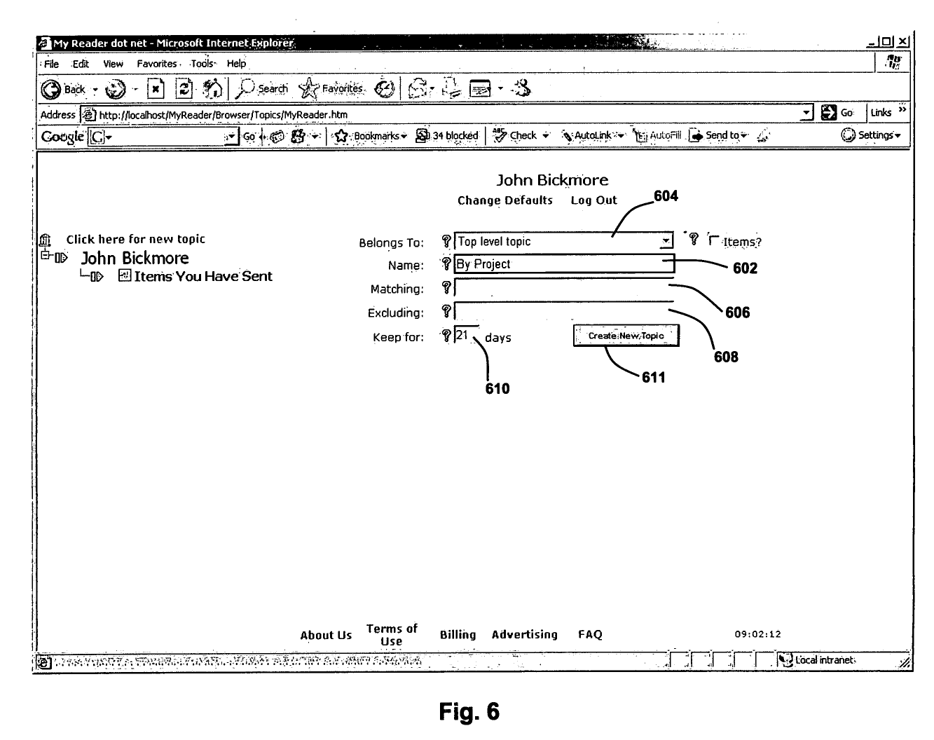

By selecting the New Topic widget 504, the user is presented with a graphical user interface such as that illustrated in FIG. 6. Referring to FIG. 6, the user is presented with several options for inputting criteria associated with a new topic. As illustrated in FIG. 6, the topic name can be input at the Name text box 602. In this case, the topic name is “By Project”. A drop-down Belongs To list 604 is also provided to enable the user to specify whether the topic is a top-level topic or whether it is a subtopic to be included under an existing topic.

Topic criteria can be input in Matching text box 606, Excluding text box 608 and Keep For text box 610. In the Matching text box 606, key words are input that are required to be in the desired electronic items. Thus, electronic items containing those keywords will be included under that topic. In the Excluding text box 608, key words which should not be found in the desired electronic items for that topic are input. Thus, electronic items containing those keywords will not be included under that topic. The Keep For text box 610 enables a user to specify the age of an electronic item that is to be included under the topic. That is, electronic items past a certain age are not included in the topic and are deleted.

After the user has input the desired topic criteria, the user can select the Create New Topic widget 611 and the new topic will be added to the topic list.

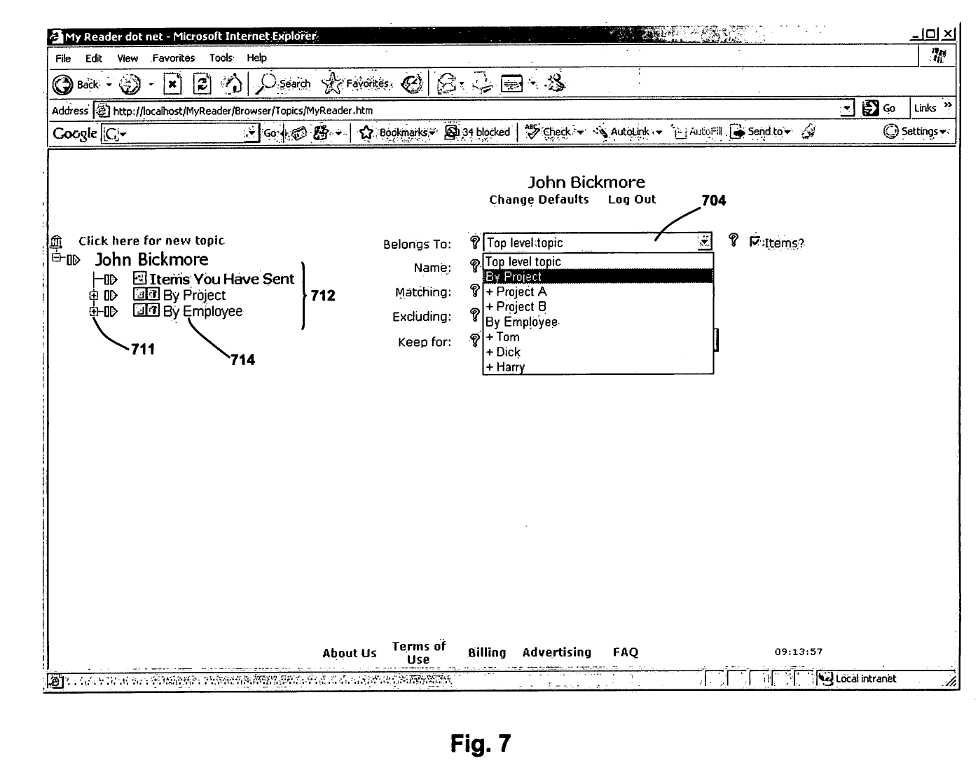

FIG. 7 illustrates a drop-down list 704 where the user specifies whether a topic is a top-level topic or is a subtopic. As illustrated in FIG. 7, the topic By Project includes two subtopics, namely Project A and Project B. Thus, the user can specify that the new topic is to be a top-level topic or is to be included as a subtopic under either one of the existing topics or subtopics in the drop-down list 704.

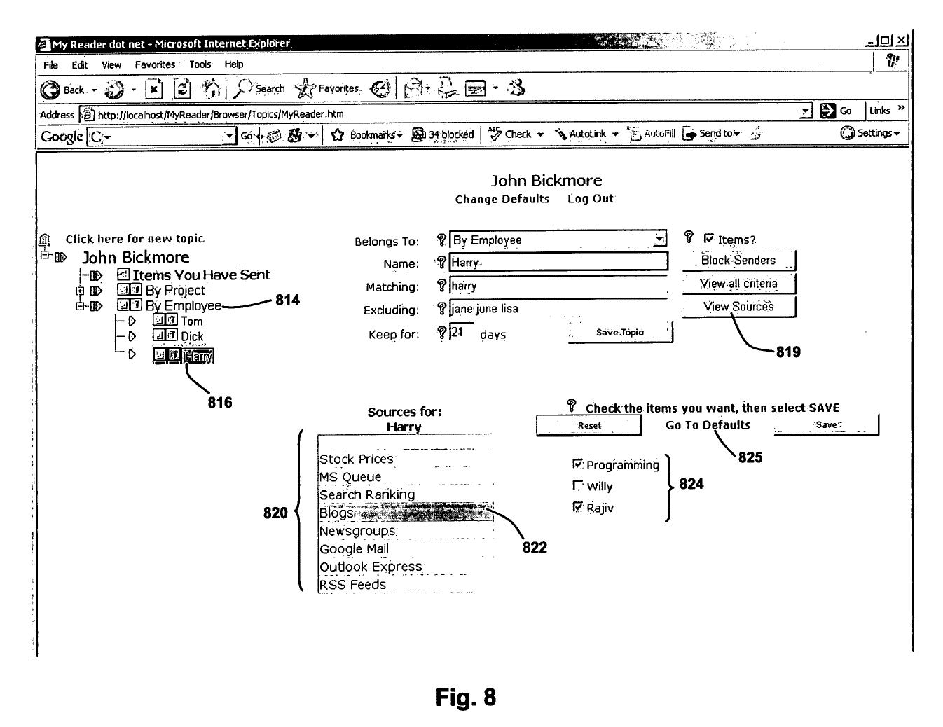

Once a topic has been created, the topic will appear in the topic list 712. Thereafter, a user can select one of the topics in the topic list 712 to then choose the electronic item sources to be used for that topic. For example, by selecting the topic By Employee 714, a graphical user interface such as that illustrated in FIG. 8 will be presented to the user. Subtopics can be listed by selecting the plus sign widget 711 to expand the hierarchal tree of topics and subtopics.

As illustrated in FIG. 8, the user has selected the top-level topic By Employee 814 and the subtopic Harry 816. As will be noted from FIG. 8, the user has input topic criteria for the subtopic Harry 816, including matching and excluding key words for electronic items to be associated with the subtopic Harry 816. It will be appreciated that the subtopic Harry 816 will inherit the topic criteria input for the top-level topic By Employee 814, in addition to the topic criteria that has been input for the subtopic Harry 816. However, it is not necessary that the topic By Employee 814 include any topic criteria. That is, the topic By Employee 814 may simply serve as an organizational placeholder for subtopics, e.g., Tom, Dick and Harry.

The user can review the electronic item sources that are available such as by selecting the View Sources widget 819 to display a source list 820. As illustrated in FIG. 8, the user has selected the electronic item source Blogs 822. Selecting the electronic item source Blogs 822 displays a list 824 of the blog names that have been input by the user (e.g., at the GUI in FIG. 2). The user can then select which of these blog names from the list 824 is to be included for the subtopic Harry 816. To create a new blog source, the user can select the Go To Defaults widget 825 to return to the GUI of FIG. 2.

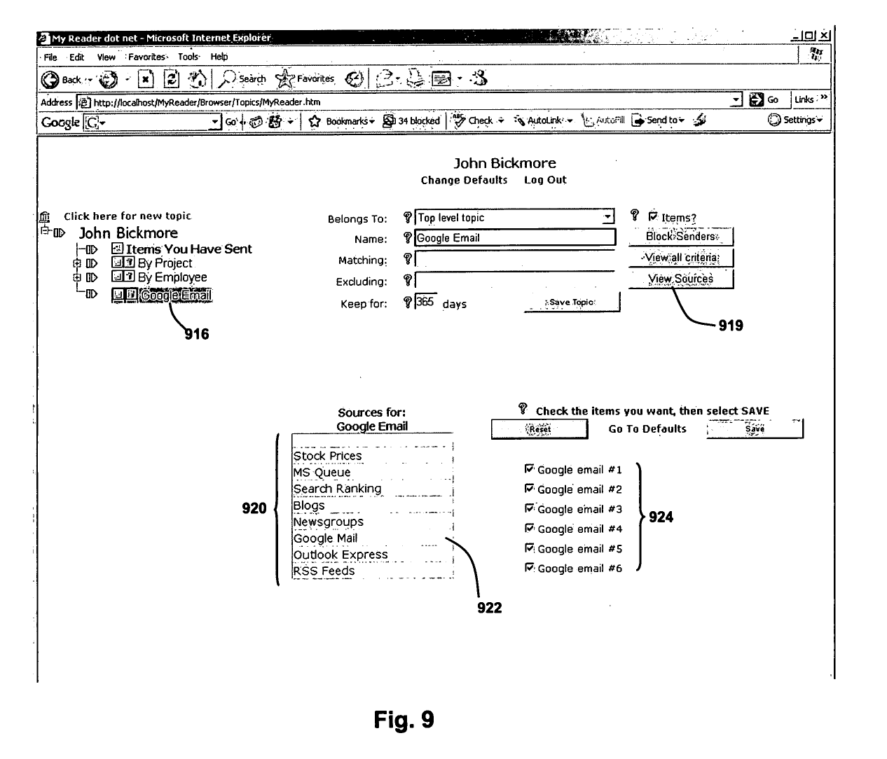

Similarly, in FIG. 9, the user has created a new topic Google E-mail 916. By selecting the topic Google E-mail 916, and the View Source widget 919 a list of sources 920 available for Google E-mail is displayed to the user. The user has selected electronic item source Google Mail 922 which causes a list 924 of Google e-mail sources that are currently available to be displayed. The user can then check the desired Google E-mail sources from the list 924 for inclusion in the Google E-mail topic 916.

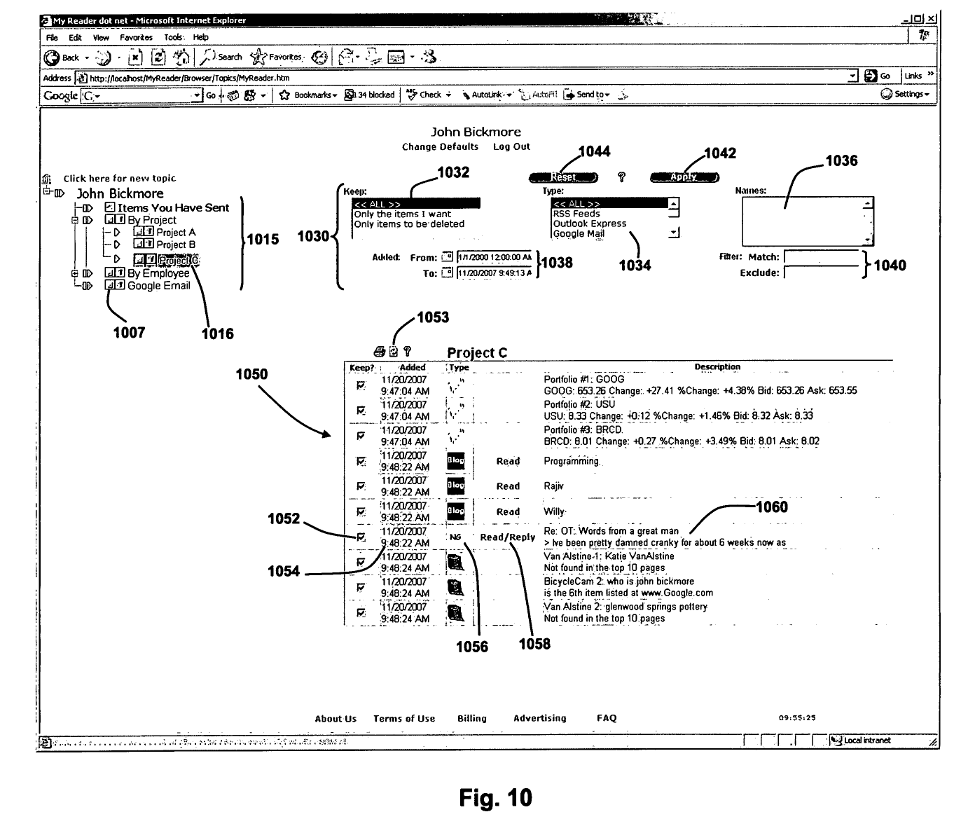

FIG. 10 illustrates a graphical user interface where a user is reviewing items under a selected topic. From the topic list 1015, a user can open a list of the electronic items associated with a topic or subtopic by selecting an open widget 1007 that is associated with the desired topic or subtopic. As illustrated in FIG. 10, the user has opened the topic Project C 1016 from the topic list 1015. This action results in the electronic items associated with Project C being displayed in a window for review by the user. According to one embodiment of the present invention, electronic items that are associated with a topic or subtopic can be filtered and reassociated by applying further selection criteria to generate a focused result set of electronic items. On the right side of the GUI, an option group 1030 of widgets for further filtering of the electronic items associated with the topic Project C 1016 is displayed. By selecting and setting these options, a focused result set can be generated for the user that is a focused set of electronic items from within the selected topic.

Among the selection criteria for creating the focused result set can be, for example, similar criteria that are used to define topics. Examples include the type of electronic item, names associated with the electronic item, dates associated with the electronic item or key words associated with the electronic item. For example, using the Keep widget 1032, the user can choose to keep all of the items, only the items that the user wants or only the items to be deleted. Thus, by checking the Keep checkboxes in the list 1050 for deletion and then selecting the “only items to be deleted” option from the Keep widget 1032, the user can review a list of items to be deleted before completing the deletion. Alternatively, or in addition to, the user can be provided with a GUI widget to delete all electronic items that match the criteria for the focused result set, thereby enabling the user to quickly delete a large number of electronic items that match a particular criteria.

The Type widget 1034 enables the user to select one or more types and/or sources of electronic items to be included in the focused result set. For example, by selecting the Google Mail choice from the list 1034, only items from sources that are part of Google Mail will be displayed.

A user can also focus the result set by inputting name criteria, such as by using the Names text box 1036. The name can be, for example, a name that is associated with an e-mail, a newsgroup posting, a blog entry or the like. The name criteria can also be a computer name or path, such as by specifying a particular Microsoft Queue.

The focused result set can also be restricted to items having a specified date or range of dates. For example, the Added widget 1038 enables a user to include electronic items in the focused result set based upon the date that the item was added to the database.

The focused result set can also be filtered by the inclusion or exclusion of keywords that are associated with the electronic items. For example, the Filter widget 1040 enables a user to filter the focused result set based upon keywords that are required to be found within the electronic items (Match), or are required to not be found in the electronic items (Exclude).

After choosing options from the widgets 1030, the user can select the Apply widget 1042 to apply the result set options and create the focused result set 1050. Selecting the Reset widget 1044, resets the option group 1030.

The focused result set 1050 is then displayed in a window. If the number of electronic items in the result set 1050 is too large to be displayed in a single window, a logical paging selection widget can be utilized to move through page windows in the focused result set 1050.

The result set window lists the electronic items and provides summary information about the electronic items so that they can be readily identified by a user. In addition, the result set window enables the user to quickly and easily take action and manipulate the electronic items from directly within the result set window. Among the functionalities provided in the result set window can be a check box 1052 associated with each electronic item. By selecting or deselecting the check box 1052, an item can be kept or deleted when the result set 1050 is refreshed by selecting the Refresh widget 1053 or when the user closes the result set window by moving to another topic or by closing the GUI. The information in the result set window can also include the date and time 1054 that the electronic item was added to the database.

Also included for each electronic item is an icon 1056 that indicates the electronic item type, such as an e-mail item, a blog entry, a newsgroup posting or the like. The GUI also includes an action widget 1058, which when selected applies an appropriate action to the electronic item depending on the electronic item type. For example, if the item is an audio file, selecting the button can play the audio file. If the electronic item is an e-mail, selecting the button can open the e-mail to enable the user to read the e-mail, reply to the e-mail or otherwise manipulate the e-mail.

In addition, the result window also provides a short description 1060 of the electronic items in the focused result set 1050. This information can include, for example, a brief description of the item or the source of the electronic item.

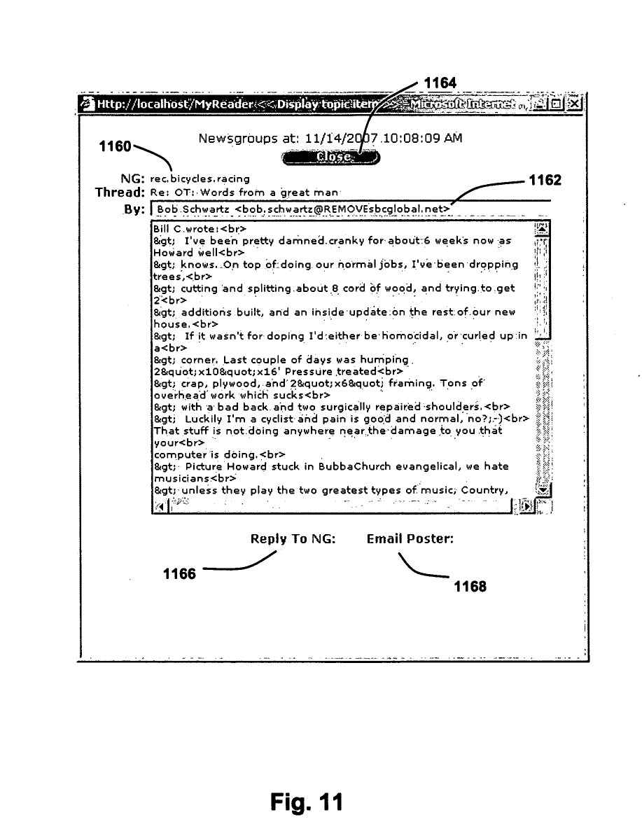

As noted, the user can open a desired electronic item from the result list window by selecting the action widget 1050. In this regard, FIG. 11 illustrates a window that appears when the user selects the action widget 1058 for the newsgroup item 1060. The window enables the user to read the newsgroup posting and then can close the window 1164 to return to the GUI illustrated in FIG. 10. The window that appears for the newsgroup item can include other information, including the name of the newsgroup 1160 and the name of the poster 1162 of the posting. The user also has the option to reply to the posting using the Reply widget 1166 or can send an e-mail to the poster by selecting the Email widget 1168.

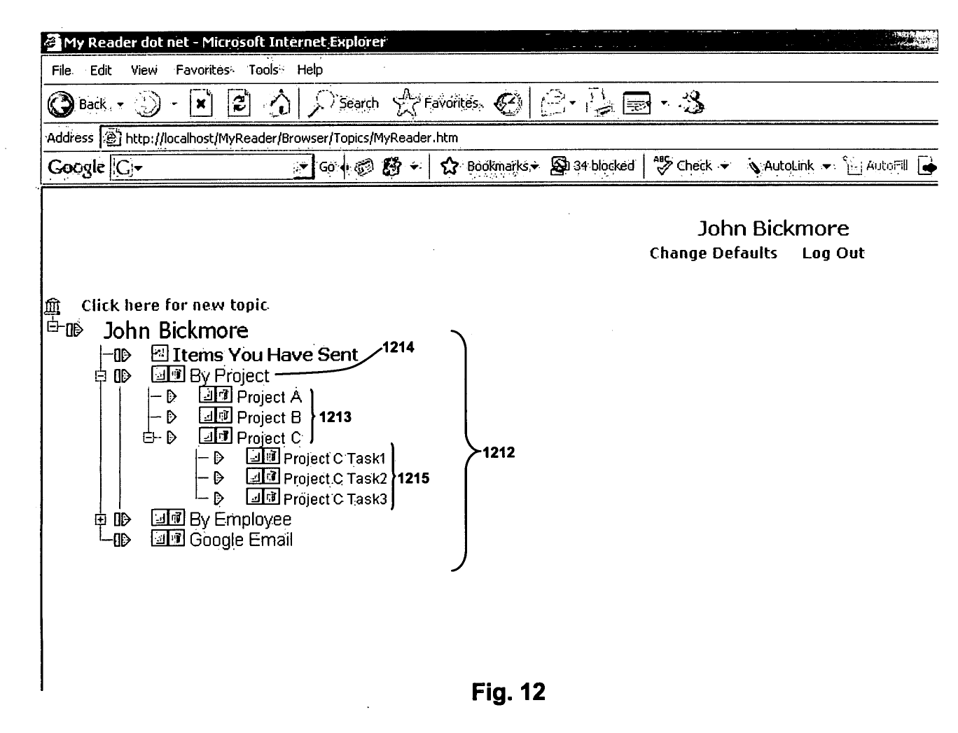

FIG. 12 illustrates a hierarchal tree 1212 which illustrates that topics and subtopics can advantageously be nested to form the hierarchal tree 1212, whereby subtopics inherit the topic criteria of the topics with which the subtopics are associated. As illustrated in FIG. 12, the top-level topic By Project 1214 includes three associated subtopics 1213. The subtopic Project C itself has three associated subtopics 1215. It will be appreciated that any given electronic item can be associated with more than one topic. For example, as illustrated in FIG. 12, an item can be associated with both a project and an employee.

Thus, the information organizer associates disparate electronic items to topics and subtopics for display to a user over a single GUI. A user can read, view, hear, see, delete, and filter to create new associations between topic items.

It is an advantage of the present invention that different types of electronic items (e.g., an email, a post to a newsgroup, a video clip, sound, etc.) do not have to be compatible with each other. The information organizer takes care of the re-association to topic criteria.

Electronic items of the same type (e.g., multiple email accounts, newsgroup servers, etc.) can be from different sources, and the information organizer takes care of the re-association to information organizer methods.

While various embodiments of the present invention have been described in detail, it is apparent that modifications and adaptations of those embodiments will occur to those skilled in the art. However, is to be expressly understood that such modifications and adaptations are within the spirit and scope of the present invention.

What is claimed is:

1. A computer-implemented method for organizing and presenting electronic item information on a client device, the method comprising the steps of:
enabling a user to select at least a first electronic item source and a second electronic item source that is different than said first electronic item source;
enabling the user to create at least a first topic having a first topic name by inputting topic criteria to a database that define said first topic;
associating a plurality of electronic items with said first topic by applying said topic criteria to said electronic items, wherein said plurality of electronic items includes at least electronic items from said first electronic item source and electronic items from said second electronic item source; and
displaying a user interface on the client device where said first topic name is displayed to the user to enable the user to select said first topic and display a list of electronic items that have been associated with said first topic

2. A method as recited in claim 1, further comprising the step of:
enabling the user to select and manipulate an electronic item from the list of electronic items associated with said first topic.

3. A method as recited in claim 1, wherein said first and second electronic item sources are selected from the group consisting of news groups, e-mail accounts, websites and web feeds.

4. A method as recited in claim 1, wherein at least said first electronic item source is a first e-mail account.

5. A method as recited in claim 4, wherein said second electronic item source is a second e-mail account that is different than said first e-mail account.

6. A method as recited in claim 5, wherein said first e-mail account is located on a first e-mail server and said second e-mail account is located on a second e-mail server that is different than said first e-mail server.

7. A method as recited in claim 1, wherein said plurality of electronic items includes an electronic item selected from the group consisting of an e-mail item, a newsgroup posting, a video file, an audio file, an image file, a blog entry, and a web feed item.

8. A method as recited in claim 1, wherein said topic criteria comprise keywords associated with said electronic items.

9. A method as recited in claim 2, wherein said step of enabling the user to select and manipulate an electronic item from the displayed list of electronic items comprises enabling a user to delete the selected electronic item.

10. A method as recited in claim 2, wherein said step of enabling the user to select and manipulate an electronic item from the displayed list of electronic items comprises enabling a user to open and view the selected electronic item.

11. A method as recited in claim 10, wherein the list of electronic items comprises a GUI widget for opening an electronic item and wherein the electronic item is automatically opened using a program that is associated with the type of electronic item.

12. A method as recited in claim 1, wherein said plurality of electronic items comprises at least an e-mail item and a newsgroup posting.

13. A method as recited in claim 1, wherein said plurality of electronic items comprises at least an e-mail item and a web feed item.

14. A method as recited in claim 1, wherein said step of enabling the user to create a first topic comprises enabling a user to create a plurality of topics.

15. A method as recited in claim 14, further comprising the step of:
enabling a user to create a subtopic associated with said first topic for creating a hierarchal list comprising topics and subtopics with which electronic items are associated.

16. A method as recited in claim 1, further comprising the step of:
enabling a user to filter the list of electronic items associated with said first topic to create a focused result set comprising a portion of said electronic items that are associated with said first topic.

17. A method as recited in claim 16, wherein said focused result set is based upon dates associated with said electronic items.

18. A method as recited in claim 16, wherein said focused result set is based upon the electronic item type.

19. A computer-implemented method for organizing and presenting electronic item information on a client device, the method comprising the steps of:
enabling a user to select at least a first electronic item source and a second electronic item source that is different than said first electronic item source;
enabling the user to create a plurality of topics by inputting topic criteria to a database that define each of said topics;
associating a plurality of electronic items with said topics by applying said topic criteria to said electronic items, wherein said plurality of electronic items includes at least electronic items from said first electronic item source and electronic items from said second electronic item source;
displaying a user interface on the client device where said topics are displayed to the user to enable the user to select a topic and display a list of electronic items that have been associated with the selected topic;
enabling a user to filter the list of electronic items associated with the selected topic to create a focused result set comprising a portion of said electronic items that are associated with said topic; and
enabling the user to select and manipulate an electronic item from the list of electronic items associated with the selected topic.

20. A method as recited in claim 19, wherein electronic items from said first electronic item source are electronic items of a first electronic item type and electronic items from said second electronic item source are electronic items of a second electronic item type that is different than said first electronic item type.
